(19) United States
(12) Patent Application Publication
(10) Pub. No.: US 2003/0004654 A1
(43) Pub. Date: Jan. 2, 2003

(54) Safety identification system and methods of same

(76) Inventor: Raymond Jusak, Duluth, GA (US)

Correspondence Address: SONNENSCHEIN NATH & ROSENTHAL, P.O. BOX 061080, WACKER DRIVE STATION, CHICAGO, IL, 60606-1080, US

(21) Appl. No.: 10/142,752

(22) Filed: May 9, 2002

Related U.S. Application Data
(60) Provisional application No. 60/289,831, filed on May 9, 2001.

(51) Int. Cl. G06F 19/00; G01N 31/00; B65D 90/02

(52) U.S. Cl. 702/22; 220/565

(57) ABSTRACT

Embodiments of the invention relate to an industrial safety/environmental protection identification system and methods of same. Embodiments of the invention comprise a system to provide visual and electronic industrial safety information for manufacturers, handlers, shippers, and the like, to provide for safer chemical management.

### CROSS-REFERENCE OF RELATED APPLICATIONS

This application claims priority to, and the benefit from, U.S. Provisional Patent Application, serial No. 60/289,831, filed May 9, 2001, the disclosure of which is entirely incorporated by reference herein.

### TECHNICAL FIELD OF THE INVENTION

Embodiments of the invention relate to an industrial safety/environmental protection identification system and methods of same. Embodiments of the invention comprise a system to provide visual and electronic industrial safety information for manufacturers, handlers, shippers, and the like, to provide for safer chemical management.

### BACKGROUND OF THE INVENTION

Some of the biggest problems associated with handling a material, such as a chemical, is knowing what the material is, how dangerous it is, and its compatibility with other chemicals or conditions. Transport vehicles, storage facilities, distribution facilities and the like are often laden with hazardous chemicals, of which the driver, recipient, or handlers may not understand the correct handling procedures. It is well documented that, without the proper identification of the material or substance, death may occur. A litany of mistakes may occur in handling, such as:

improper transport of the substance;

improper storage environment (too hot, too cold, too humid, too dry, etc.);

improper cleaning of the substance carrier (e.g., the carrying drum);

improper mixing of substances to create noxious gas;

exothermic/endothermic reactions;

polymerization; and

explosions.

While understanding the commercial implications of industrial chemical activities, it is also well documented that handlers are often unskilled workers, with little formal education in science, and may even include the illiterate. Accordingly, the safety protocols in place may escape the handlers' attention since the protocols are often too complex to comprehend. Thus, industry reliance on Manufacturer's Safety Data Sheets (“MSDS”) that describe the sheer volume of information on the shipped product is misplaced. MSDS sheets often are too complex, illegible, and perhaps even missing. In this regard, sheer speculation is needed to determine the container contents, a task that should not be left to the undisciplined.

Two solutions proposed are: (1) by the NFPA (National Fire Protection Association); and (2) by the HMIS (Hazardous Material Information System). They use a four-color coding system, all four colors displayed on each identified package with a number from zero (0) to four (4) portrayed in each color category to identify the severity of various risks. More precisely, these systems may track the acute health risk, the flammability, corrosivity, and reactivity; each category identified by a color and within each color a number from 0-4 to indicate the respective risk. The problems are that these systems do not give the user enough information because they merely identify a limited risk, do not provide why the risk exists, and are confusing.

Regarding this last point, all four colors are presented collectively in each display label; only the numbers (from 0 to 4) change. Thus, easy recognition is hampered. Few people can remember if the number 1 or 4 is the higher risk, and four colors do not satisfactorily delineate chemical exposures. For example, the prior systems may identify that a particular chemical is corrosive, but does not indicate whether it is acidic or caustic. Mixing or co-mingling these two chemically opposite corrosives is very dangerous. Unskilled workers fail to appreciate the symbols, what they mean, how to discern difference through further chemical investigation and how the system operates. Additionally, those that may have difficulty distinguishing between various colors have a higher risk of recognition error.

### SUMMARY OF THE INVENTION

The foregoing problems are solved and a technical advance is achieved by the present invention. Disclosed is a system to provide visual and electronic industrial safety information for manufacturers, handlers, shippers, and the like, to provide for safer handling.

Various figures are attached that provide a detailed description of various embodiments of the invention.

It should be understood that the foregoing relates only to a limited number of embodiments that have been provided for illustration purposes only.

### BRIEF DESCRIPTION OF THE DRAWINGS

FIG. 1 is a diagram of one system level embodiment of the invention.

FIG. 2 is a flowchart.

FIG. 3A is an exemplary template form.

FIG. 3B is a flow diagram of an exemplary process.

FIG. 4 is one mode of operation.

FIGS. 5A and 5B show exemplary search results.

FIGS. 6A and 6B show alternate exemplary search results.

FIG. 7 shows alternate information that may be shown.

FIG. 8 shows an exemplary display form of the management code.

FIGS. 9A to 9C show exemplary MSDS sheets.

FIG. 10 shows an exemplary table of colors.

FIG. 11 shows an exemplary severity code table.

FIGS. 12A to 12D show exemplary alternate product information.

### DETAILED DESCRIPTION OF THE INVENTION

The term “manage” or derivations thereof includes, but is not limited to, to handle, store, clean, process, dispose, manipulate, wash, mix, immix, transport, ship, separate, aerate, dissolve, solubilize, gel, react, moisten, dry, polymerize, burn, volatize, neutralize, acidify, caustify, bury, or the like.

One embodiment of the invention comprises a system, either electronic or non-electronic, in which safety information about a particular material is conveyed to the user. In this embodiment, a color code and a severity code of a spectrum are used to denote particular safety information. The color code may indicate the nature of the chemical, such as the family of chemicals, the name, the IUPAC (International Union of Pure and Applied Chemistry) name, the established name, the trade names, etc. The severity code may indicate how severe the risk is.

For example, embodiments of the invention may comprise a color to indicate some information as shown herein. The color code may comprise a word that appears in a specific color. In addition, the color code may also comprise the actual name color spelled out as a word, e.g., Y E L L O W (with each letter appearing in yellow color). In this regard, even color-blind workers may use the system because, even though they cannot see the actual yellow color, they can read the word “yellow” and act accordingly. For the language impaired, all the user needs is to read the word associated with its respective color, versus being able to read a long complex chemical name. In addition, even illiterates can be taught how to recognize the spelled-out color name or to recognize the color. The color may indicate chemicals of like attributes or characteristics, such as the name and color yellow representing all compatible acids. Thus, the code may comprise a plurality of colors.

By way of example only, a color code may be charted as follows:

| Color | Code |
|---|---|
| Green | Non-Hazardous Material |
| Yellow | Corrosive Acid |
| Blue | Corrosive Base |
| Red | Flammable |
| Pink | Combustible |
| Purple | All Isocyanates Materials and Derivatives |
| Light Blue | Oxidizer and/or Peroxide |
| Lime | Toxic/Poison/Fungicide/Herbicide/Pesticide/Rodenticide |
| Maroon | Miscellaneous Hazardous Material |

A severity code may also be used, such as a numeric code. This may indicate an exposure indicia such as a 1 to 10 scale, with 1 being relatively benign and 10 being extremely risky.

A customizable code may follow that provides for user-specific requirements. For example, this customizable annotation may include an “A” which may code for an instruction to rinse the container with detergent water only; or a “B” to code for the instruction to store the container at the back of the warehouse only in an open, or well-ventilated, area. The customizable section may address any chemical management instruction.

The resulting color+severity+customizable codes may be collectively called a management code. Of course, the customizable code is optional. For example, the management code may be “YELLOW 4 B” given the example above. The management code also may be the color code, the color code plus the severity code, the color code plus the severity code plus the customizable code, the color code plus the customizable code, or the severity code plus the customizable code.

The information used in the system may be derived from sources such as MSDS sheets. The MSDS sheets can be found in paper form and then scanned into the system or may come in electronic form, such as a storage disk or other computer-readable memory device. The compilation of MSDS sheets may also comprise a database, which can be from time to time supplemented with more data as the situation requires. Thus, it is contemplated that MSDS sheets can be periodically updated in various embodiments.

Embodiments of the invention may also reside in software on a computer medium, over a network, or over an internet-type system. Thus, embodiments of the invention may reside on various servers, networks, or computers. Persons of ordinary skill in the art can appreciate how to implement embodiments of the invention on an electronic medium. The system also may provide links to various other sites such as manuals, government agencies, regulatory authorities, manufacturer's sites, magazines, articles, or the like. In essence, embodiments of the invention may link to any site that can provide information about the material in question, its handling, reuse, recycling, disposal, transportation, etc. For example, it allows for proper DOT (Department of Transportation) shipping information, including proper shipping name, packaging group, class, UN (United Nations) Number, etc., derived from a product name. Links may also be provided to the chemical manufacturer's home page, product catalogs, trade reports, EPA reports, local environmental regulatory materials, shipping companies, trade associations, etc.

Since technology permits logistics to be computerized, the embodiments of the invention may partially reside in a computerized form. For example, the embodiments of the invention may include a computer program embodied on a tangible medium, such as a disk drive, CD-ROM, network, floppy disk, zip drive, or server, to correlate or associate the information into the form of embodiments of the invention. The computer assembly may include a first set of instructions to determine what is the chemical in question; a second set of instructions to determine where in the databases or software the chemical information resides; a third set of instructions to generate the form of the display; and a fourth set of instructions to provide the desired information or to provide links to other sites. A computer system may receive any or all of the instructions to perform the embodiments of the invention.

The embodiments of the invention may also reside in a signal. The signal may further include other signals that: (a) signal the chemical in question; (b) identify the appropriate location of the chemical information; and (c) display the information in a desired format and/or provide links to other information. It is appreciated by those skilled in the art that the process shown herein may selectively be implemented in hardware, software, or a combination of hardware and software. An embodiment of the process step employs at least one machine-readable signal-bearing medium. Examples of machine-readable signal bearing media include computer-readable media such as a magnetic storage medium (i.e., hard drives, floppy disks), or optical storage such as compact disk (CD) or digital video/versatile disk (DVD), a biological storage medium, or an atomic storage medium, a discrete logic circuit(s) having logic gates for implementing logic functions upon data signals, an application-specific integrated circuit having appropriate logic gates, a programmable gate array(s) (PGA), a field programmable gate array (FPGA), a random access memory device (RAM), read only memory device (ROM), electronic programmable random access memory (EPROM), or equivalent. Note that the computer-readable medium even could be paper (e.g., tape or punch cards) or another suitable medium, upon which the computer instruction is printed, as the program can be electronically captured, via for instance optical scanning of the paper or other medium, then compiled, interpreted or otherwise processed in a suitable manner if necessary, and then stored in a computer memory.

Additionally, machine-readable signal bearing medium includes computer-readable signal bearing media. Computer-readable signal-bearing media have a modulated carrier signal transmitted over one or more wire-based, wireless or fiber optic network or within a system. For example, it may also be one or more wire-based, wireless or fiber optic network, such as the telephone network, a local area network, the Internet, or a wireless network having a component of a computer-readable signal residing or passing through the network. The computer-readable signal is a representation of one or more machine instructions written in, or implemented with, any number of programming languages.

Furthermore, the multiple process steps implemented with a programming language, which comprises an ordered listing of executable instructions for implementing logical functions, can be embodied in any machine-readable signal bearing medium for use by or in connection with an instruction execution system, apparatus, or device, such as a computer-based system, controller-containing system having a processor, microprocessor, digital signal processor, discrete logic circuit functioning as a controller, or other system that can fetch the instructions from the instruction execution system, apparatus, or device and execute the instructions. As with any embodiment, the results (either partial or complete) may be displayed and converted from form to form, e.g., from electronic to paper form.

Thus, the computer assembly may comprise a computer system that includes CPU's, memory, memory caches, processors, storage devices, servers, displays, databases, external devices, peripheral accessories, external disks or other storage media, software, etc. These components may be configured to optimize the desired performance or desired layout.

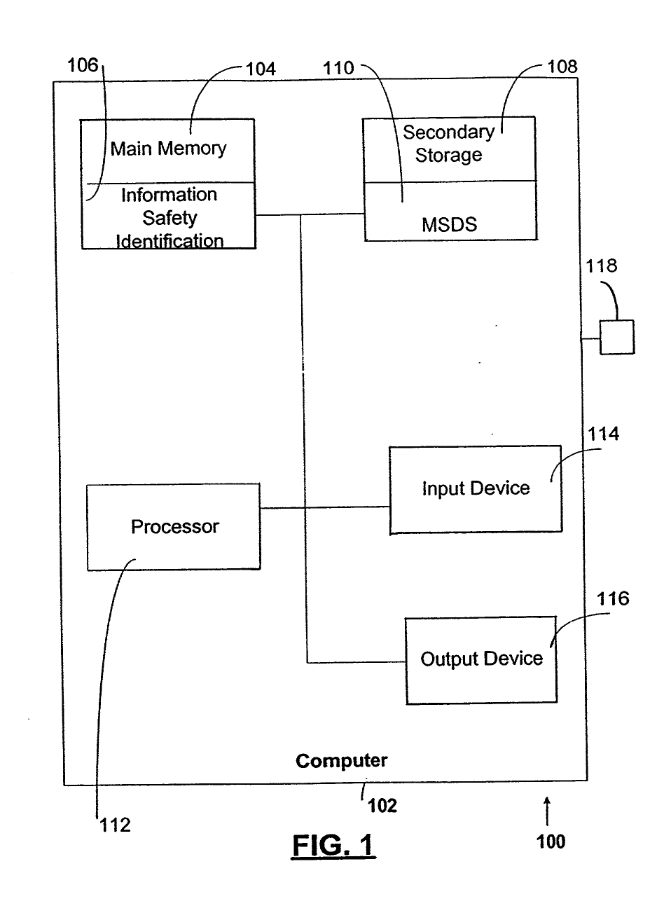

FIG. 1 shows a data processing system suitable for producing methods and systems consistent with the present invention. Data processing system 100 includes a computer system 102 connected to the Internet 118, which further comprises a main memory 104, with an information safety identification program 106, a secondary storage 108, with a database 110 of, for example, MSDS sheets, a processor 112, an input device 114, an output device 116, and an Internet 118. Thus, upon use, the program 106 receives an input from the user such as the search query. The program 106 then obtains the MSDS sheet from the database. The program 106 then receives the appropriate coordination of the MSDS to the search request and then receives the appropriate color code and severity code, and the customizable code if configured so. The program 106 may also display the MSDS sheet. The computer system then receives the display request and displays the result electronically or non-electronically.

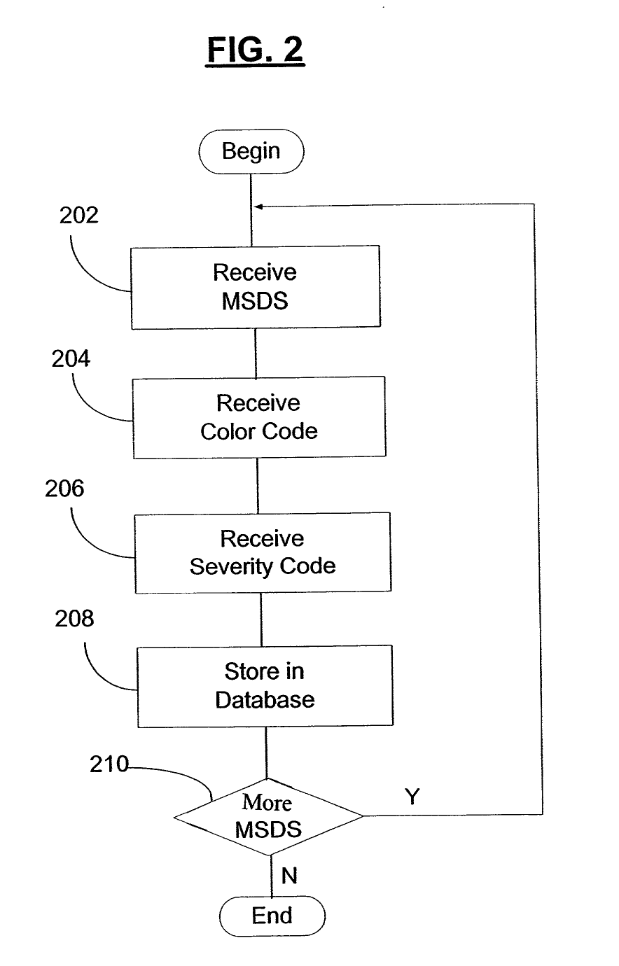

As generally shown in FIG. 2, the MSDS database may be updated periodically by an administrator. As new MSDS sheets are created by manufacturers, they create the sheet and send it out to the public. The administrator may then input the MSDS sheet, such as scanning it, into the MSDS database. The MSDS database can be accessed, the new MSDS sheet may be added to the database, the color code and the severity code may be added, the information added is then stored in the database, and the process continues until no more MSDS sheets are required to be added to the database. In particular, the MSDS sheet may be received (step 202), the color code received (step 204), the severity code received (step 206), and this information stored in a database (step 208). More MSDS sheets may be added to the database by redoing the steps (step 210).

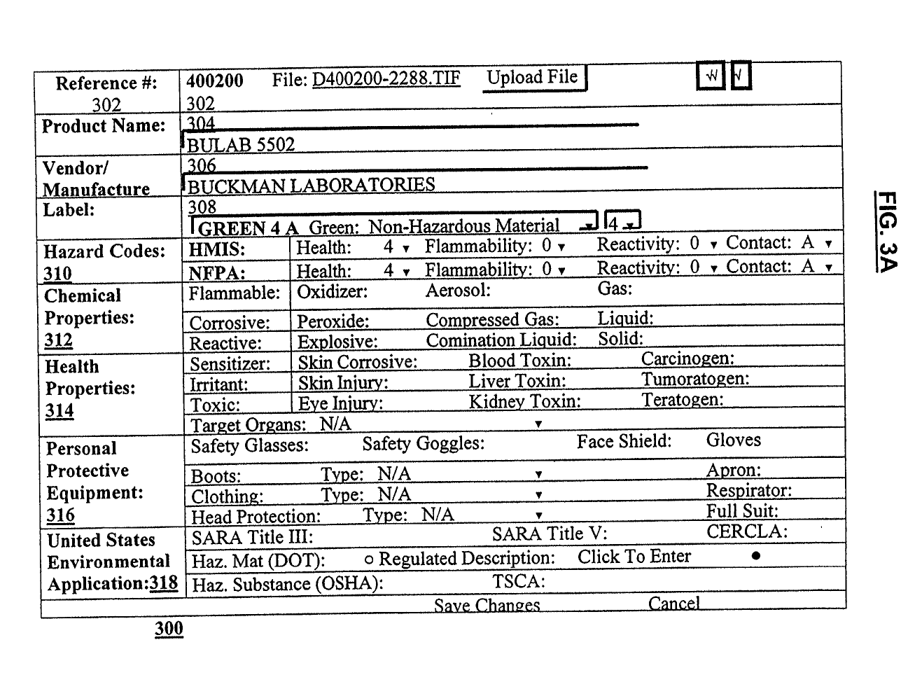

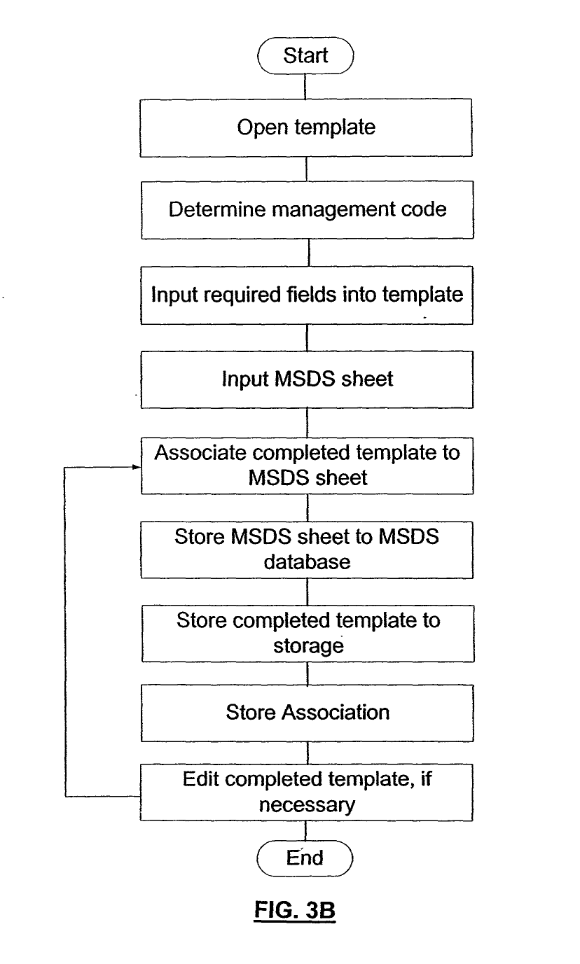

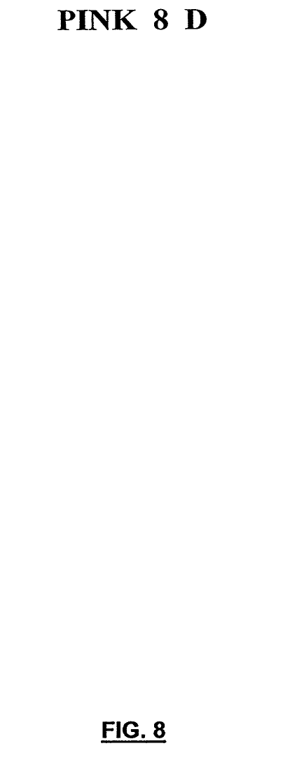

FIG. 3A demonstrates an exemplary template form 300 that may be used to input a new MSDS sheet and create the required codes. Upon opening the template 300, the system may be configured to provide a reference number 302. The reference number 302 may be sequentially assigned. The template 300 may also include a product name field 304, in which to input the product name, such as shown for BULAB 5502. The template 300 may also include a vendor field 306, in which to provide the vendor's name or manufacturer's name, which in this example is Buckman Laboratories. Upon receiving the MSDS sheet, responsible personnel such as the operations management or handling management will examine the MSDS sheet and determine the nature of the chemical, its comparable color code, and its severity code. The template 300 provides a management code field 308 in which the responsible personnel will insert the proper color, severity, and other handling codes. In this example, a drop-down box may also have the universe of color codes, the universe of severity codes, and the universe of other codes. In this example, responsible personnel have judged that BULAB 5502 deserves a GREEN 4 A code, indicating that BULAB 5502 is a non-hazardous material, and that it poses a severity code 4 indicating a moderate health risk (see FIG. 8 and above table). Other relevant information on template 300 may be inputted such as the hazard codes 310, chemical properties field 312, health properties field 314, the personal protective equipment needed field 316, and the EPA field 318. In this regard, the system is configured so that, once the desired information is inputted, it will be saved, for example, to the secondary storage 108. The system may also save this information into a database for subsequent retrieval. Of course, it is well understood that the number or types of fields of information sought can vary. That is, the system may provide for more inputted information or less. In addition, the template need not be configured as shown in FIG. 3A and may be configured in any format.

Furthermore, the actual MSDS sheet may be also inputted (e.g., by scanning or electronically capturing the sheet) into the MSDS database and coded such that the template 300 just filled out is associated with the MSDS sheet. One modality of doing so is to key the reference number 302 to the MSDS sheet. Associations to the MSDS sheet also may be done via any other field in the template 300. In this regard, the MSDS sheet is associated with a particular completed template 300. Thus, this process is repeated each time a new MSDS sheet is received.

FIG. 3B shows a flow diagram of the process. This flow chart essentially repeats the steps generally described above. Ancillary information such as DOT, EPA, or other information can be inputted into the template 300.

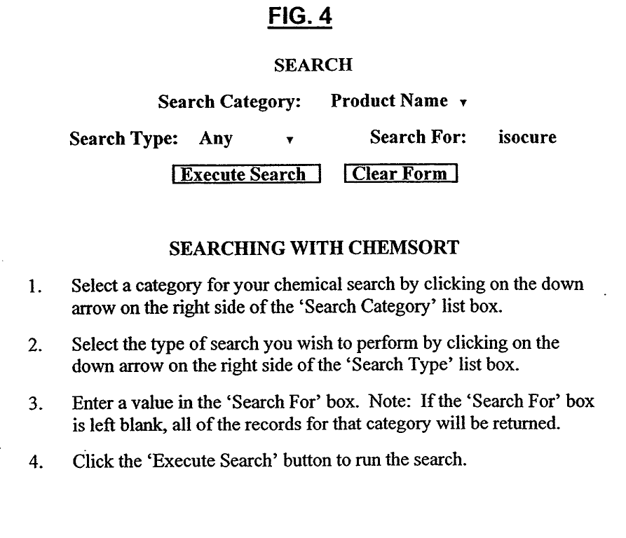

FIG. 4 shows one mode of customer operation. An operator may input a search term, for example, “isocure” as the product name of the material in question to be managed. In this example, the search term is inputted into the “Search For” field. As is also indicated, the “Search Category” may include search capabilities of the product name, the MSDS number, the manufacturer name, manufacturer number, plant or location name, plant or location number, or the like. In addition, the “Search Type” field may also be coded to provide for Boolean or natural language search capabilities. The search engine may be programmed to search out any or all of the fields of the template 300. In this case, because the user typed in the term “isocure” as the product name, an association is made between this search term and the product name field 304 of template 300. The search engine may search the entire database to find all completed template sheets in which the product name field 304 includes the term “isocure” in it. The system would extract both the MSDS sheet and the completed template that corresponds to the MSDS sheet. The system would then display the MSDS sheet and the management code as more fully described herein.

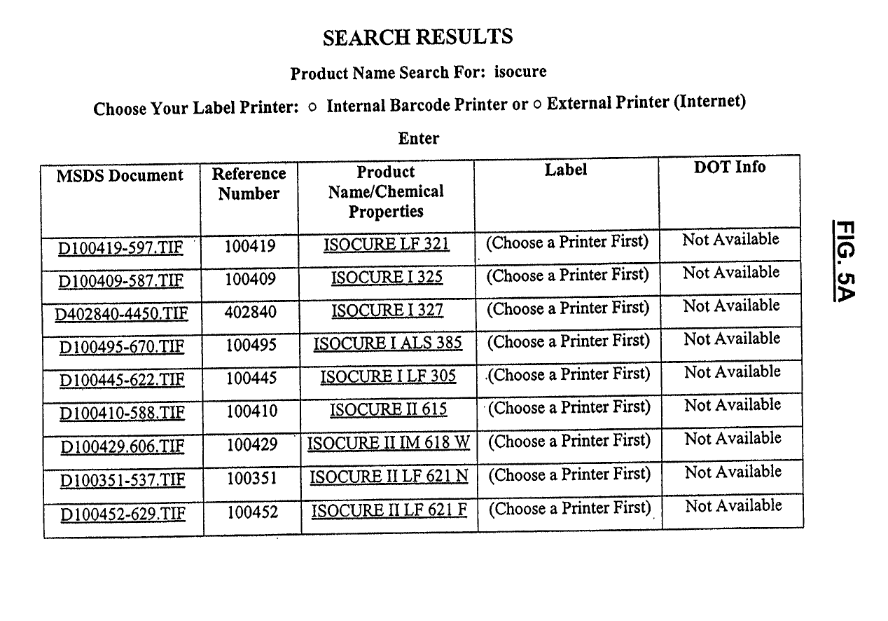

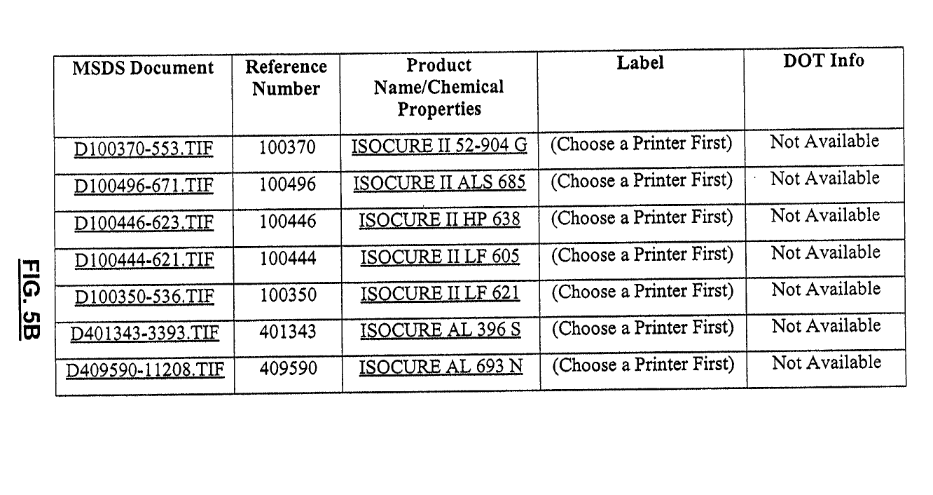

FIGS. 5A and 5B show the search results and may be displayed in tables showing any number of results. In this example, FIG. 5A shows the results for “isocure” as identified near the top of the table. For example, many MSDS sheets may be available for Isocure. These Figures also show that printer selection for printing or labeling is an option.

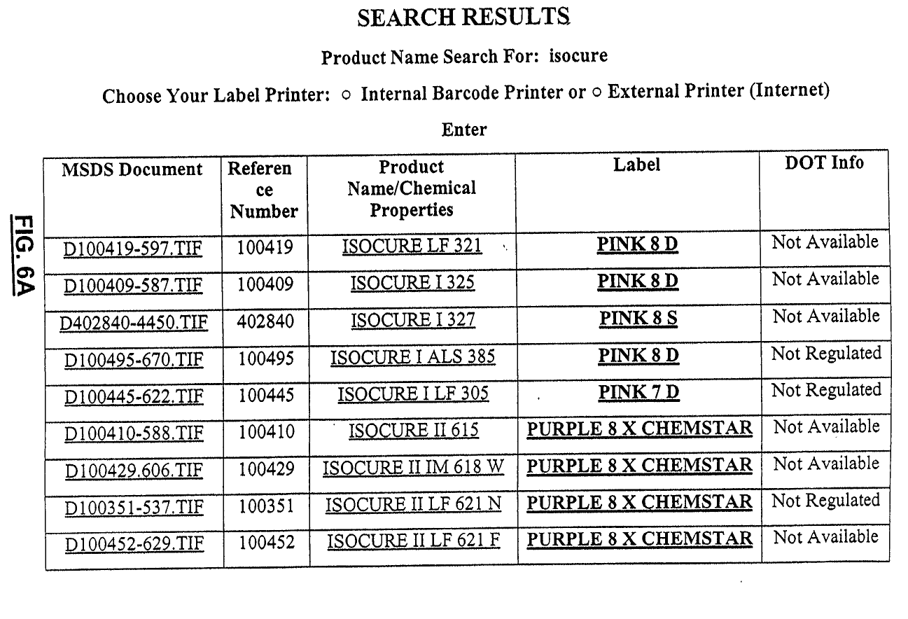

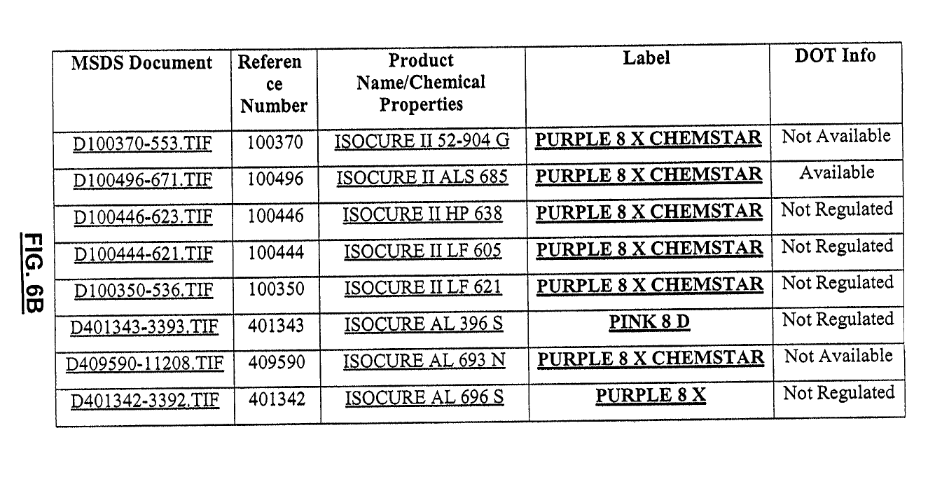

FIGS. 6A and 6B show an alternate form of the results. Shown is the management code in the “label” column. For example, examining a desired Isocure, for example, LF 321, will reveal the information, such as the chemical classification by color, chemical properties, health properties, and whether types of personal protective equipment are needed. In this case, the label column indicates a management code of PINK 8 D. Any field in FIGS. 5A, 5B, 6A, and 6B may include various links, such as hyperlinks or other links to other areas of the program or to retrieve other information.

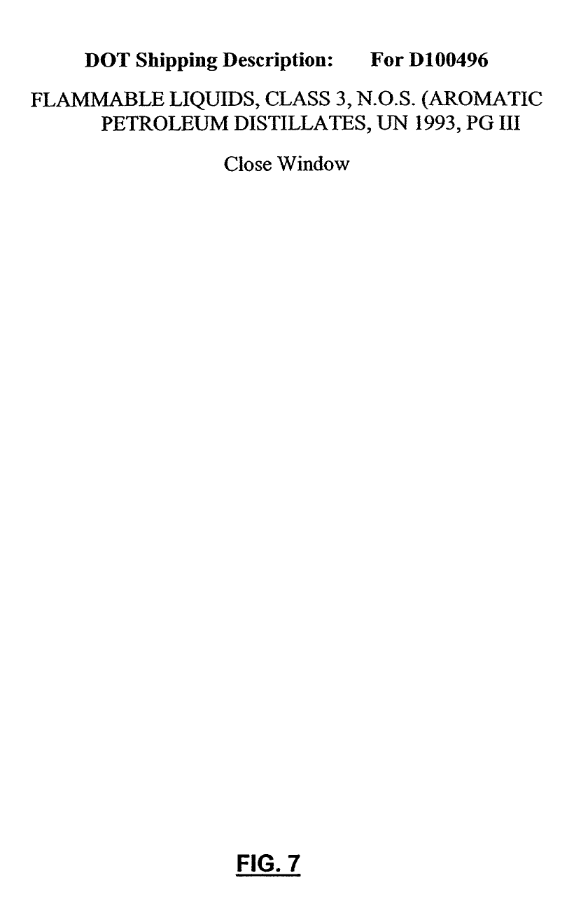

For example, examining FIG. 6B in conjunction with FIG. 7, the entry for Isocure II ALS 685 (the second row), has DOT information as “available”. By choosing that field under the DOT Info column, FIG. 7 shows DOT shipping descriptions, such as Isocure II ALS 685 being a flammable liquid, class 3, etc.

Accordingly, as shown in FIGS. 6A and 6B, in this example, selecting Isocure LF 321 would reveal that its management code is:

PINK 8 D (as shown in FIG. 6A)

with at least the word “PINK” appearing in a pink color. In various embodiments, the severity code and/or customizable code could also appear in the pink color (or appropriate color). It is also understood that the codes may be in any language.

FIG. 8 shows how the management code could appear either on a display, monitor, label, adhesive label, screen, or any other display mode. Again, at least the word “PINK” would appear in the pink color and the remainder of the management code could appear in the same or different color.

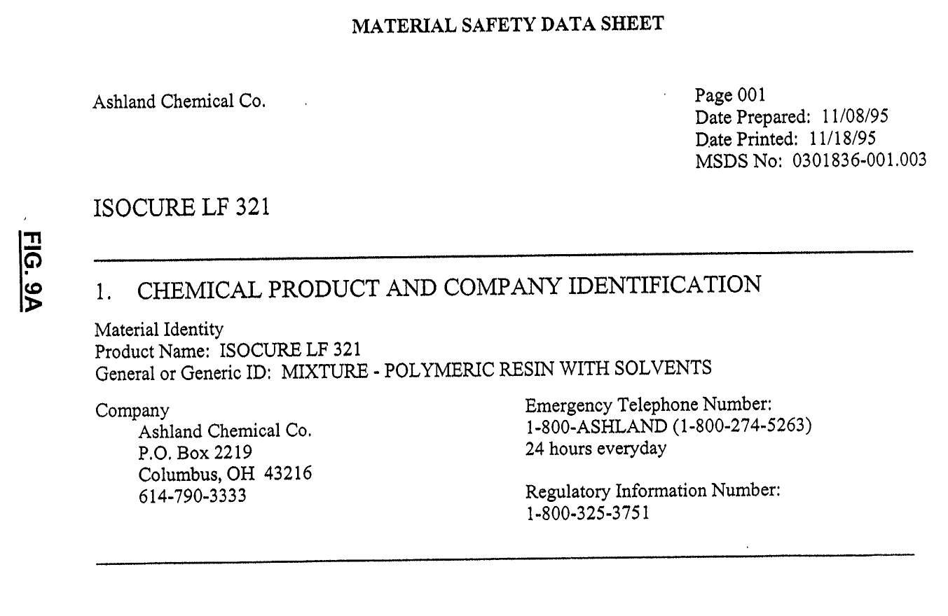

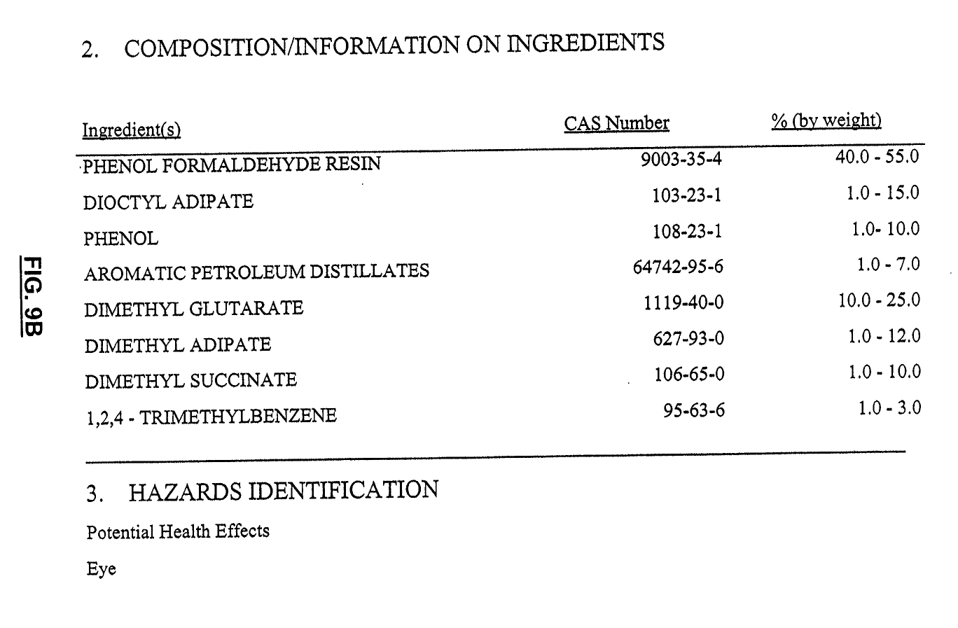

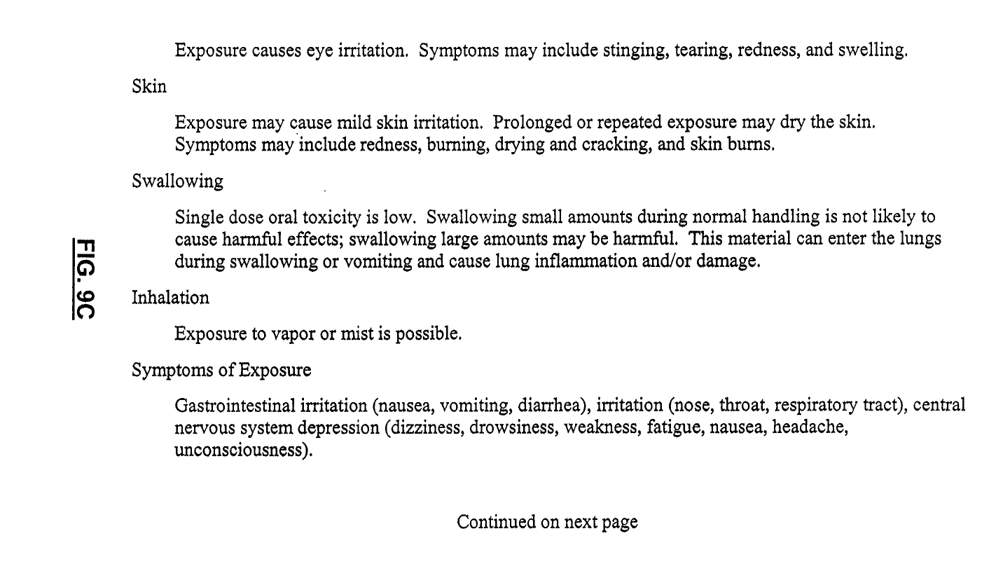

Returning to FIG. 6A, if the user requires more information, such as the MSDS sheet itself, the user may select the field and obtain the MSDS sheet. For example, selecting the Isocure LF 321 field in FIG. 6A under the “MSDS Document” column, the actual MSDS sheet (as shown in FIGS. 9A to 9C) could be displayed and/or printed. Accordingly, FIG. 6A demonstrates that various choices exist on what further information is desired or what the management code will be. Of course, the fields that can be chosen may vary to provide better service to the user.

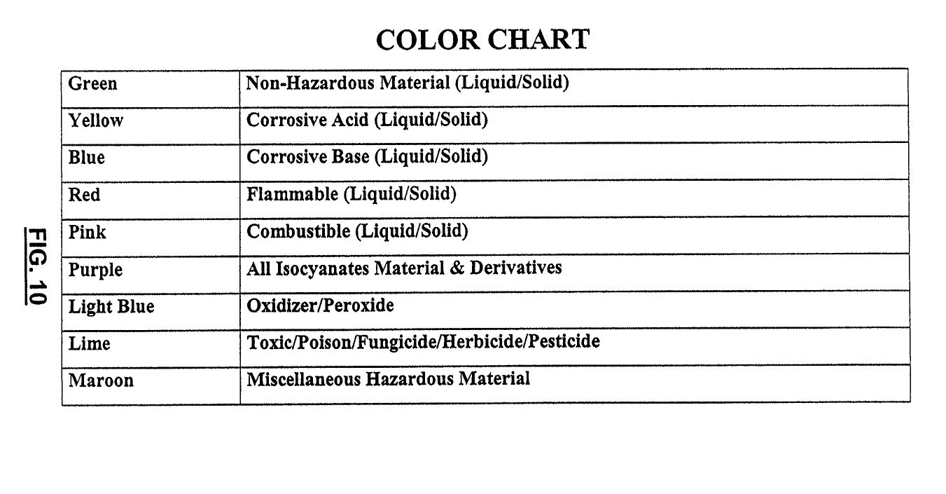

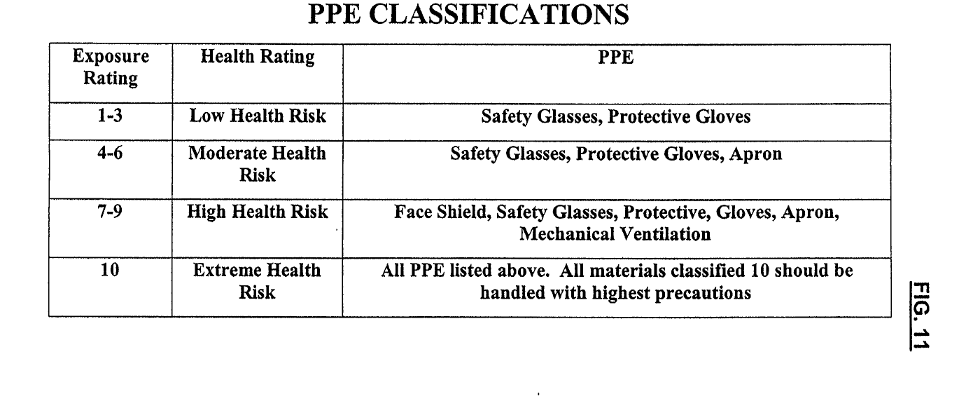

Returning to the example of the PINK 8 D, as shown in FIGS. 10 and 11, this would indicate to the handler, even without knowing what Isocure LF 321 precisely was, would now know that it is PINK and thus corresponds to a Combustible (liquid or solid). As shown in FIG. 11, the health rating and handling instructions, such as the personal protective equipment, are provided. In this example, the Isocure LF 321 has a high health risk. Accordingly, the handler should protect himself by wearing face shields, glasses, protective gloves, aprons, and mechanical ventilation. In this example, a table is provided to demonstrate the exposure rating, the health rating, and the personal protective equipment (PPE) suggested. It is well understood that the colors shown in FIG. 10 are not the only colors available. The entire color palette is available for use. The use of more colors may assist users in better managing the chemicals. Similarly, although the PPE classifications in FIG. 11 are numbered 1 to 10 and are grouped, it is well understood that the universe of available numbers is infinite and that the numbers need not be grouped.

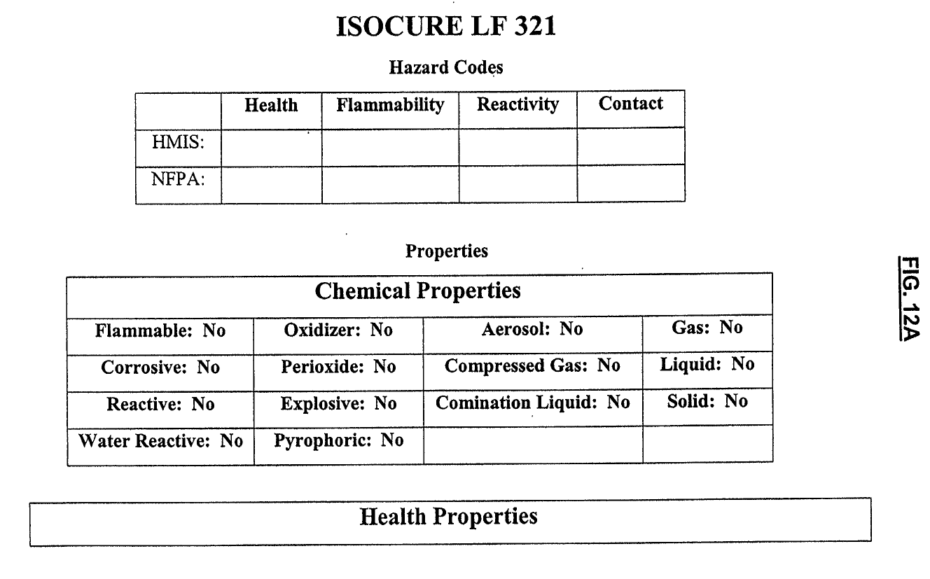

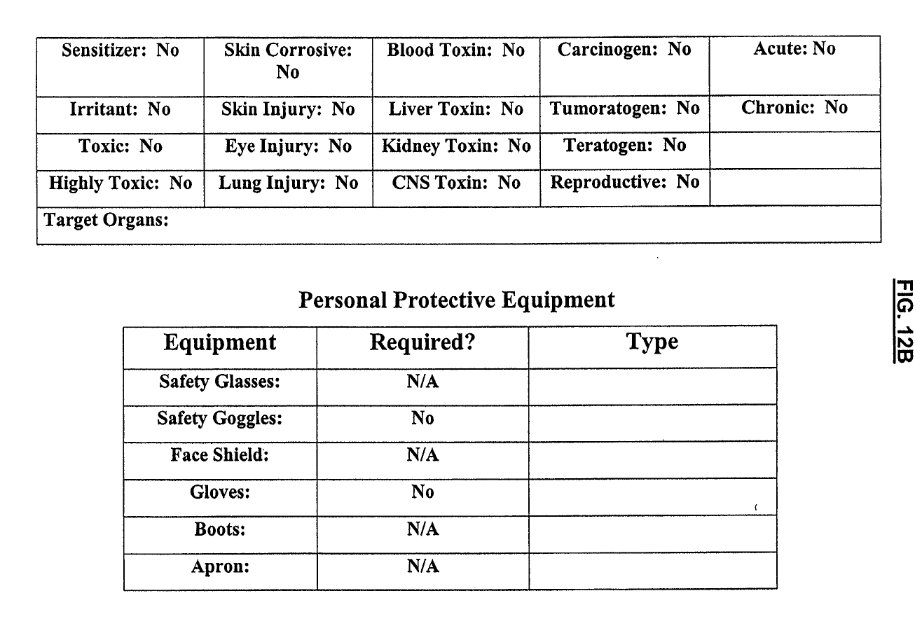

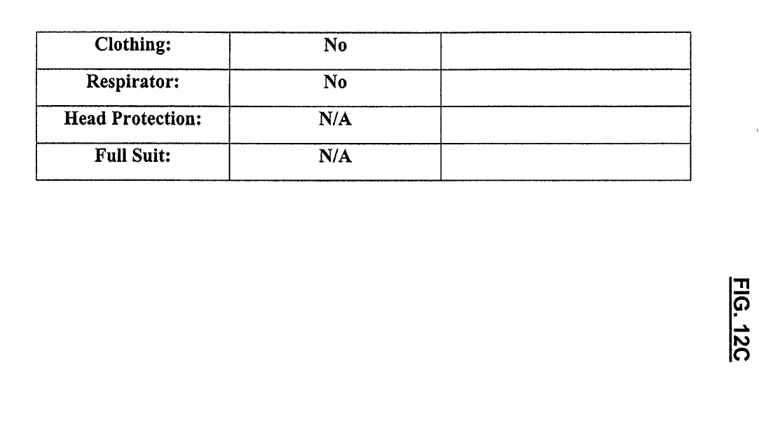

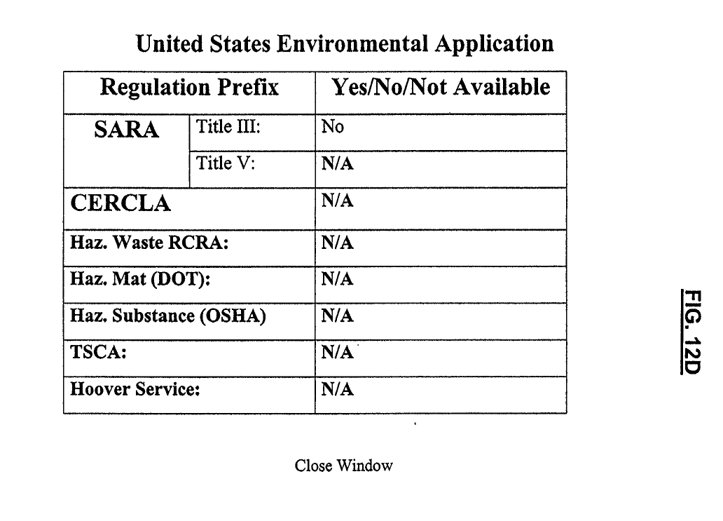

Returning to FIG. 6A, by selecting the “product name/chemical property” field, the user may then obtain further information about Isocure 321. For example, FIGS. 12A to 12D demonstrate the information, such as hazard codes, properties, health properties, the PPE suggested, and other governmental data such as Environmental Protection Agency (EPA) data.

Furthermore, the templates may be added to or refined to provide for more information. In addition, a previously-existing completed template may be edited. For example, if through the course of material handling it is found that a particular management code is not correct, e.g., the severity code is too low, the management code can be edited to change the severity code to a higher number to reflect the increased concern about safety. Thus, a severity code can change from something more benign to a riskier code.

Embodiments of the invention may comprise a system to identify materials within a container, comprising a material indicator; or a method to identify materials within a container, comprising the step of associating or coordinating a material indicator to the container. Embodiments of the invention may also include a system that permits users to input the information and create the associations and/or management codes; or may also include a system to permit a user to retrieve predetermined associations and/or management codes.

It should be understood that the foregoing relates only to a limited number of embodiments that have been provided for illustration purposes only. It is intended that the scope of invention is defined by the appended claims and that modifications to the embodiments above may be made that do not depart from the scope of the claims.

I claim:

1. A system to manage the content of a container, comprising:
a management code comprising at least one color code;
the at least one color code representing a color name and in which the color name is spelled out.

2. The system of claim 1, wherein the management code further comprises a severity code.

3. The system of claim 1, wherein the management code further comprises a customizable code.

4. The system of claim 1, wherein the management code further comprises a severity code and a customizable code.

5. The system of claim 1, wherein the at least one color code is associated with at least one characteristic of the container content.

6. The system of claim 5, wherein the management code further comprises a severity code.

7. The system of claim 6, wherein the management code further comprises a customizable code.

8. The system of claim 2, wherein the severity code comprises a numeric code.

9. The system of claim 4, wherein the severity code comprises a numeric code.

10. The system of claim 1, wherein the system comprises an information safety identification program.

11. The system of claim 1, wherein the system comprises a numeric severity code, and wherein the at least one color code is associated with at least one characteristic of the container content.

12. The system of claim 11, wherein the system comprises an information safety identification program.

13. A system to determine chemical management, comprising:
(a) a first set of instructions to receive a query;
(b) a second set of instructions to retrieve an association between the query and a management code; and
(c) a third set of instructions to generate a display of the association.

14. The system of claim 13, wherein the system further comprises a fourth set of instructions to retrieve a MSDS sheet corresponding to the chemical query.

15. A method of managing the content of a container, comprising:
(a) associating a management code with a container content; and
(b) storing the associated management code in a database.

16. The method of claim 15, wherein the method further comprises:
(c) retrieving the associated management code in response to a search query.

17. The method of claim 16, wherein the method further comprises:
(d) displaying the associated management code where a color name is spelled out.

18. A method of managing the content of a container, comprising:
(a) inputting chemical information;
(b) associating a management code with the chemical information;
(c) storing the associated management code in a database.

19. The method of claim 18, wherein associating the management code further includes associating a color code, wherein the color code includes a color name wherein the color name is spelled out.

20. A method of managing the content of a container, comprising:
(a) determining a management code for a content;
(b) inputting at least the management code into a template;
(c) associating an information sheet corresponding to the content to the management code;
(d) storing the associated management code and associated information sheet in at least one database; and
(e) retrieving the associated management code from the database.

21. A signal-bearing medium having encoded machine-readable instructions, comprising:
a first set of machine-readable instructions for retrieving a management code in response to a query; and
a second set of machine-readable instructions for retrieving an association that associates the management code to the query
a third set of machine-readable instructions for displaying the association.

22. The signal-bearing medium of claim 21, wherein the management code comprises at least one color code.

23. The signal-bearing medium of claim 21, wherein the management code comprises at least one severity code.

24. The signal-bearing medium of claim 22, wherein the management code comprises at least one severity code.

25. A system for providing information about the management of the contents of a container, comprising:
(a) a means for retrieving a management code; and
(b) a means for displaying the management code.

26. The system of claim 25, wherein the means for retrieving the management code includes querying a computer system to obtain the management code.

27. The system of claim 25, wherein the means for retrieving the management code includes a means for linking to other container content information.

28. A system for providing information about the management of the contents of a container, comprising:
(a) a means for inputting management information;
(b) a means for storing the management information;
(c) a means for correlating the management information to a management code; and
(d) a means for retrieving the management code.

29. The system of claim 28, wherein the means for inputting management information includes a means for linking to other container content information.
